(19) United States
(12) Patent Application Publication
(10) Pub. No.: US 2015/0269365 A1
(43) Pub. Date: Sep. 24, 2015

(54) METHOD AND APPARATUS FOR PLAYING MEDIA CONTENT BASED ON DIGITAL RIGHTS MANAGEMENT

(71) Applicant: Samsung Electronics Co., Ltd., Suwon-si (KR)

(72) Inventors: Eric YIP, Suwon-si (KR); Bo-Gyeong KANG, Seoul (KR); Sung-Ryeul RHYU, Yongin-si (KR)

(21) Appl. No.: 14/664,009

(22) Filed: Mar. 20, 2015

Related U.S. Application Data
(60) Provisional application No. 61/955,991, filed on Mar. 20, 2014.

(30) Foreign Application Priority Data
Mar. 19, 2015 (KR) 10-2015-0038471

(51) Int. Cl. G06F 21/10; H04L 29/06; H04L 29/08

(52) U.S. Cl. CPC G06F 21/105; H04L 67/10; H04L 63/08

(57) ABSTRACT

A method for playing content included in a media file in a playback apparatus is provided. The method includes obtaining file status indication information indicating a status of the media file from the media file, determining whether a Content Authentication Code (CAC) for playback of the content is included in the media file, if the file status indication information indicates that the content included in the media file is self-encoded content, and playing the content, if the CAC is not included in the media file. The self-encoded content is content that can be played without the CAC.

### CROSS-REFERENCE TO RELATED APPLICATION(S)

This application claims the benefit under 35 U.S.C. §119(e) of a U.S. Provisional application filed on Mar. 20, 2014 in the U.S. Patent and Trademark Office and assigned Ser. No. 61/955,991, and under 35 U.S.C. §119(a) of a Korean patent application filed on Mar. 19, 2015 in the Korean Intellectual Property Office and assigned Serial No. 10-2015-0038471, the entire disclosures of which are hereby incorporated by reference.

### TECHNICAL FIELD

The present disclosure relates to a method and apparatus for providing a Digital Rights Management (DRM) service.

### BACKGROUND

Digital Rights Management (DRM) refers to a technology and service for protecting and managing the rights and interests of the intellectual property rights and copyright of digital content owners. DRM technology allows only users who are permitted to access and consume content to enjoy the content.

DRM technologies may be roughly divided into a software-based DRM scheme and a media-based DRM scheme. The media-based DRM scheme is a scheme of restricting the consumption of digital content to specific media such as a locked-in flash memory, thereby limiting the consumption of digital content within the media. On the other hand, the software-based DRM scheme does not use any scheme of limiting the consumption of digital content to specific hardware.

In order to improve security for content protection while providing higher flexibility than device-based DRM (or the media-based DRM), the software-based DRM scheme has been developed so that the content may be linked to specific media.

In this regard, in Blu-ray Disc Association (BDA), which is the standardization organization associated with Blu-ray Disc (BD), a BD bridge system is under discussion. The BD bridge system is for copying content included in a BD in other media (e.g., a hard disc in a computer, or a memory card of a mobile device), to allow the user to consume the content. In the BD bridge system, Standard File Format (SFF) compatible with Common File Format (CFF), which is used as the standard format for digital copying and image transmission, has been defined, and allows the user to consume the content included in the BD that he/she has purchased, on a device supporting SFF. However, since the BD bridge system has a digital copyright problem, it is necessary to allow only the user with a legitimate authority to consume the content included in the BD.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for including information indicating a status of a media file in the media file, and performing a licensing operation or a playback operation related to the media file based on the information indicating a status of the media file by a playback apparatus.

Another aspect of the present disclosure is to provide a method and apparatus for performing a licensing operation or a playback operation related to a media file depending on whether content included in the media file is self-encoded content or prepared content.

Another aspect of the present disclosure is to provide a method and apparatus for performing a licensing operation or a playback operation related to a media file depending on whether content included in the media file has been licensed through Digital Rights Management (DRM) before.

In accordance with an aspect of the present disclosure, a method for playing content included in a media file in a playback apparatus is provided. The method includes obtaining file status indication information indicating a status of the media file from the media file, determining whether a Content Authentication Code (CAC) for playback of the content is included in the media file, if the file status indication information indicates that the content included in the media file is self-encoded content, and playing the content, if the CAC is not included in the media file. The self-encoded content is content that can be played without the CAC.

In accordance with another aspect of the present disclosure, a playback apparatus for playing content included in a media file is provided. The playback apparatus includes a media file analyzer configured to obtain file status indication information indicating a status of the media file from the media file and a controller configured to determine whether a CAC for playback of the content is included in the media file, if the file status indication information indicates that the content included in the media file is self-encoded content, and to play the content, if the CAC is not included in the media file. The self-encoded content is content that can be played without the CAC.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a scheme of playing a Standard File Format (SFF) file in accordance with a media-based Digital Rights Management (DRM) scheme by Digital Bridge Export Function (DBEF) of Blu-ray Disc Association (BDA) according to an embodiment of the present disclosure;

FIG. 2 illustrates a structure of an SFF common file format including Content Authentication Code (CAC) flag information according to an embodiment of the present disclosure;

FIG. 3 illustrates a DRM system according to an embodiment of the present disclosure;

FIG. 4 illustrates a method for content licensing and playing on DRM media according to an embodiment of the present disclosure;

FIG. 5 illustrates an operation of a DRM device for prepared content, for which a CAC flag is not present, according to an embodiment of the present disclosure;

FIG. 6 illustrates an operation of a DRM device for prepared content, for which a CAC flag is present, according to an embodiment of the present disclosure; and

FIG. 7 illustrates an operation of a DRM device for self-encoded content, for which a CAC flag is present, according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A method and apparatus proposed in the present disclosure may be applied to a variety of communication systems such as a Long-Term Evolution (LTE) mobile communication system, an LTE-Advanced (LTE-A) mobile communication system, a High Speed Downlink Packet Access (HSDPA) mobile communication system, a High Speed Uplink Packet Access (HSUPA) mobile communication system, a High Rate Packet Data (HRPD) mobile communication system of 3rd generation project partnership 2 (3GPP2), a Wideband Code Division Multiple Access (WCDMA) mobile communication system of 3GPP2, a CDMA mobile communication system of 3GPP2, an Institute of Electrical and Electronics Engineers (IEEE) 802.16m communication system, an Evolved Packet System (EPS) and a Mobile Internet Protocol (Mobile IP) system.

The present disclosure will be described below based on a Standard File Format (SFF) file of the Blu-ray Disc (BD) bridge system. However, this is merely for convenience of description, and the present disclosure is not intended to be limited only in the BD bridge system.

Generally, software-based DRMs may be implemented on common file formats such as Common File Format (CFF) of Dolby Digital Entertainment Content Ecosystem (DECE) or SFF of BD Association (BDA), but in order to play content included in a common format file, the media-based Digital Rights Management (DRM) scheme additionally requires DRM-specific information.

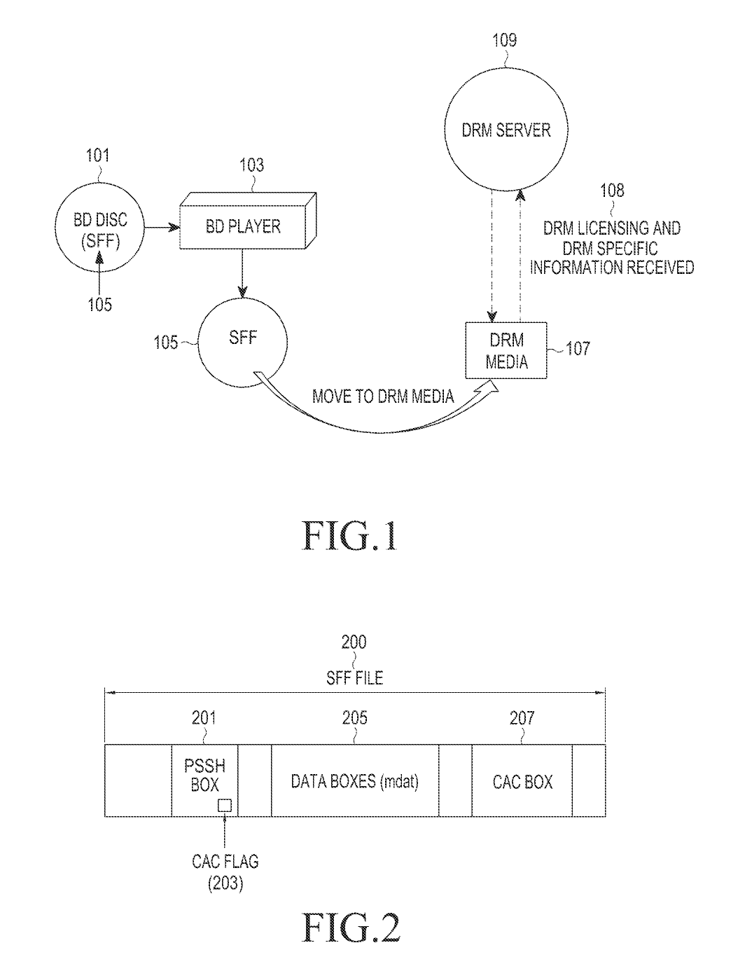

FIG. 1 illustrates a scheme of playing an SFF file in accordance with a media-based DRM scheme by Digital Bridge Export Function (DBEF) of BDA according to an embodiment of the present disclosure.

Referring to FIG. 1, if a BD 101 including an SFF file 105 is inserted into a BD player 103, the BD player 103 may move the SFF file 105 to a user's DRM device (not shown) including DRM media 107. The DRM media 107 may be in the form of, for example, a flash memory such as a Secure Digital (SD) card.

The DRM media 107, to which an SFF file 105 is moved, may additionally receive DRM-specific information through a DRM licensing procedure with a DRM server 109 (see 108), and may play content included in the SFF file using the received DRM-specific information. For reference, the ‘licensing procedure’ refers to a procedure through which the DRM device may obtain legitimate rights to play the SFF file.

However, the existing common file formats such as SFF may not provide sufficient information by which the DRM device can implement the media-based DRM scheme. Even though the SFF includes DRM-specific information required for playback of content, the DRM-specific information in the SFF may be typically included in a Protection System Specific Header (PSSH) in the SFF. However, the PSSH box is not enough to provide licensing information used by media-based DRMs, because the size or function of the PSSH box is limited. In addition to the limited size or function, there may be other reasons why the SFF may not provide sufficient information to implement the media-based DRM scheme.

In the licensing procedure for the media-based DRM scheme, Content Authentication Code (CAC) information may be included in a CAC box that is included in the SFF file. The CAC information may include a set of hash values that are calculated from a content file included in a media data (mdat) box. This licensing scheme is one of the schemes that are used in the media-based DRM schemes to couple the content to the media.

The basic idea of the present disclosure is to insert ‘file status indication information’ indicating a status of a media content file, into a file including media content. The DRM device may obtain the file status indication information, and based thereon, perform operations such as content playback or a licensing procedure with the DRM server.

In the present disclosure, the file including media content may be a common format file such as SFF. Herein, for convenience of description, the SFF file by DBEF of BDA will be assumed as an example of the common format file. However, this is merely for convenience of description, and the present disclosure is not intended to be limited only to the SFF file by DBEF of BDA.

In an embodiment of the present disclosure, the file status indication information may be included in the PSSH box in the SFF file. However, the file status indication information should not necessarily be included in the PSSH box, and may be included in any proper position within the SFF file.

The file status indication information may be flag type information having a size of, for example, 1 bit. For convenience of description, the file status indication information will be referred to herein as ‘CAC flag information’ having a 1-bit size. Therefore, in the present disclosure, the ‘file status indication information’ may be interchangeably used with ‘CAC flag information’.

In the file status indication information, the ‘status’ of a file may refer to (1) whether the file has been licensed with respect to specific media at least once before, and (2) whether the file includes prepared file content or self-encoded file content.

For reference, the ‘self-encoded content’ refers to content, for which the CAC information is not required in the SFF file in order to reproduce the content. Therefore, the DRM device does not require receiving CAC information from the DRM server for playback of the self-encoded content during the DRM licensing procedure. On the other hand, the ‘prepared content’ refers to the content, for which the CAC information is required in the SFF file in order to reproduce the content. Therefore, the DRM device may receive CAC information from the DRM server for playback of the prepared content during the DRM licensing procedure, and insert the received CAC information into the SFF file.

FIG. 2 illustrates a structure of an SFF common file format including CAC flag information according to an embodiment of the present disclosure.

Referring to FIG. 2, an SFF file 200 may include a PSSH box 201 and at least one data box (e.g., mdat box) 205. The PSSH box 201 may include 1-bit CAC flag information 203 proposed in the present disclosure, and the CAC flag information 203 may indicate a status of the SFF file 200. In addition, the SFF file 200 may further include a CAC box 207 that includes CAC information.

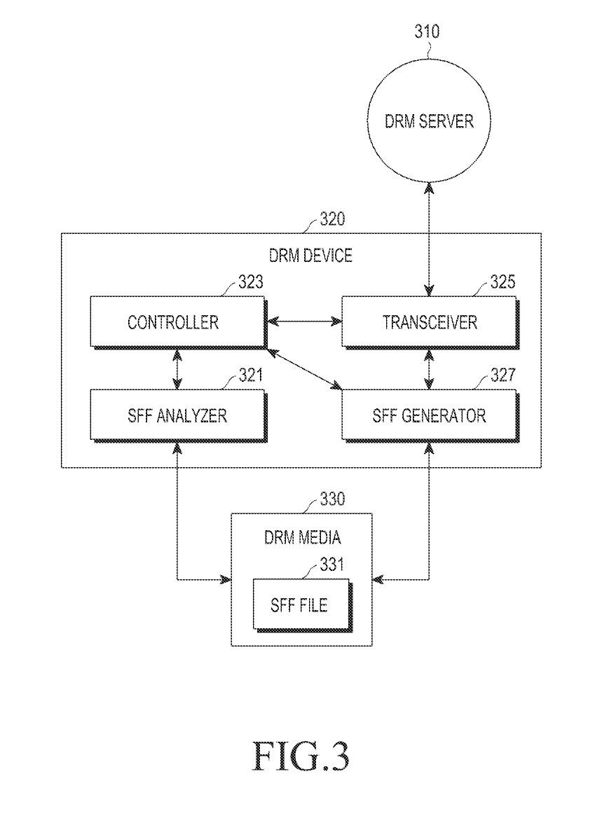

FIG. 3 illustrates a DRM system according to an embodiment of the present disclosure.

Referring to FIG. 3, the DRM system according to the present disclosure may include a DRM server 310, a DRM device 320, and an SFF file 331 in DRM media 330.

The DRM device 320 may include an SFF analyzer 321, a controller 323, a transceiver 325 and an SFF generator 327. In FIG. 3, since SFF is an example of a media file, ‘SFF’ in the name of each block can be replaced by ‘media file’. For example, the SFF analyzer 321 may be referred to as a media file analyzer.

The SFF analyzer 321 may analyze components included in an SFF file. In an embodiment of the present disclosure, the SFF analyzer 321 may detect CAC flag information and identify a value of the CAC flag information. In addition, the SFF analyzer 321 may analyze offsetToCAC information capable of indicating the presence/absence of a CAC box and the position of the CAC box, and output the results. The “offsetToCAC” may not exist if CAC box does not exist, but an attempt to read the offsetToCAC is performed regardless of value of the CAC flag, since the reading of the offsetToCAC is an extra check to verify that the content in SFF file was licensed properly.

The SFF analyzer 321 may analyze the SFF file to determine the presence/absence of a CAC flag, and identifies a value of the CAC flag if the CAC flag is present. The SFF analyzer 321 may also analyze offsetToCAC to find a position of the CAC box, and identify the CAC box. In addition, the SFF analyzer 321 may deliver the analysis results to the controller 323.

The controller 323 may receive the information (e.g., information about the presence/absence of a CAC flag, a value of the CAC flag, and the presence/absence of a CAC box) provided from the SFF analyzer 321, and control the overall operation of the DRM device 320 based on the received information. For example, based on the information, the controller 323 may determine to receive DRM-specific information from the DRM server 310 for content playback through a licensing procedure with the DRM server 310, or may determine to play the content without the licensing procedure or to stop the operation without the playback of the content. The DRM-specific information may include CAC information, Next Generation Secure Memory (NSM)-specific PSSH files, an XORed title key, and/or the like. The XORed Title key is generated from at least one of a title key, a usage rule, and a CAC signature. The title key is stored encrypted and stored in a storage medium as the XORed title key. If the controller 323 determines to receive DRM-specific information from the DRM server 310, the transceiver 325 may request and receive DRM-specific information from the DRM server 310.

The SFF generator 327 may insert 1-bit CAC flag information having a predetermined value in a specific position (e.g., into a PSSH box) in the SFF file. In addition, the SFF generator 327 may insert CAC information into a CAC box, using the DRM-specific information received from the DRM server 310.

The DRM media 330, media such as a flash memory (e.g., an SD card), may include an SFF file 331 as media to which legitimate rights to consume the content are granted.

The DRM server 310 may receive a request for DRM-specific information from the transceiver 325 in the DRM device 320, and provide the DRM-specific information to the DRM device 320 in response to the request. The DRM-specific information may include CAC information, DRM-specific PSSH files, an XORed title key, and/or the like.

The CAC flag information according to an embodiment of the present disclosure will be described below.

The CAC flag information may have a predetermined size (e.g., 1 bit), and may be inserted into a PSSH box of an SFF file stored in DRM media. In addition, the CAC flag information may be inserted into the PSSH box, if the SFF file has been licensed through specific media-based DRM at least once before. If the SFF file has not been licensed through specific media-based DRM, the CAC flag information may not be inserted.

If the CAC flag information is inserted, a CAC flag value may indicate whether content in the SFF file is self-encoded content or prepared content. For example, if a value of the CAC flag information is set to ‘0’, it indicates that the SFF file includes ‘self-encoded content’ and CAC information is not required for content playback. If a value of the CAC flag information is set to ‘1’, then the SFF file includes ‘prepared content’ and CAC information is required for content playback. Obviously, however, the value of the CAC flag information may be set inversely.

The ‘self-encoded content’ refers to the content, for which the CAC information in the SFF file is not required in order to reproduce the content. The CAC flag value of the self-encoded content is set to ‘0’ by a home device which is a device for generating an SFF file. On the other hand, the ‘prepared content’ refers the content, for which the CAC information in the SFF file is required in order to reproduce the content, and the CAC information may be received from the DRM server during the DRM licensing procedure, and inserted into the SFF file.

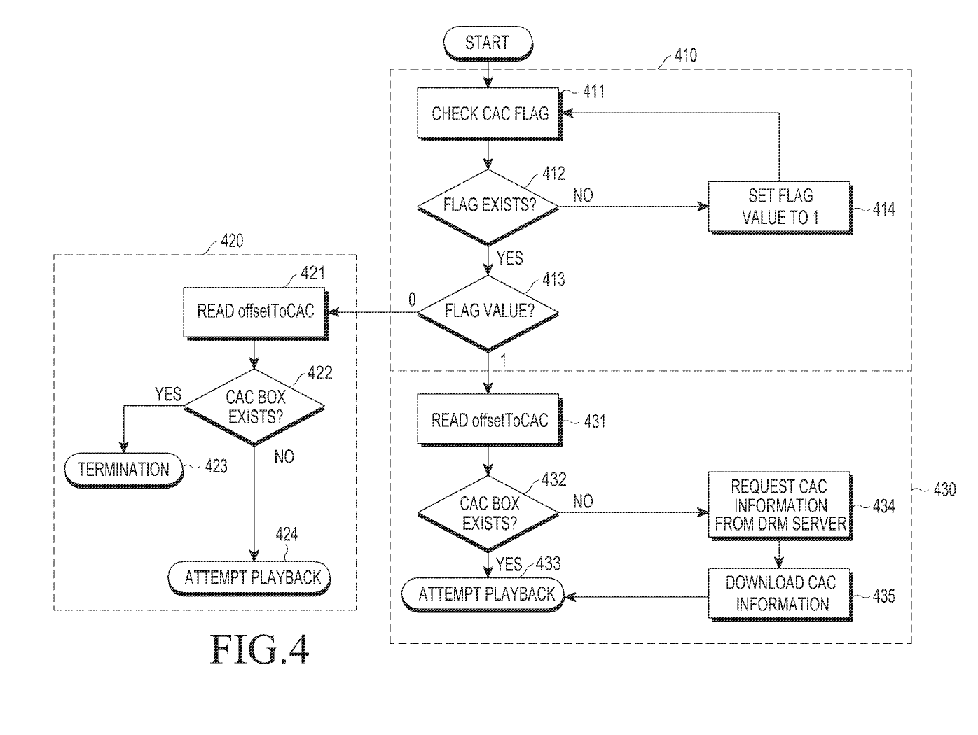

FIG. 4 illustrates a method for content licensing and playing on DRM media according to an embodiment of the present disclosure.

Referring to FIG. 4, for convenience of description, the operation of FIG. 4 will be divided into 3 partial operations.

A first operation 410 is a process of determining the presence/absence of a CAC flag in an SFF file, and identifying a value of the CAC flag. A second operation 420 is a process of determining whether a CAC box is present in the SFF file, if a value of the CAC flag bit is 0. A third operation 430 is a process of determining whether a CAC box is present in the SFF file, if a value of the CAC flag bit is 1. A detailed description thereof is as follows.

In operation 411, a DRM device may determine the presence/absence of a CAC flag. If the CAC flag is not present in operation 412, the DRM device may insert a CAC flag into the SFF file in operation 414. For reference, as described above, if the SFF file has not been licensed through specific media-based DRM, the CAC flag information may not be inserted into the SFF file. Therefore, if the CAC flag is not present, then the SFF file has not been licensed through specific media-based DRM.

In operation 414, the DRM device may insert a CAC flag into the SFF file, since the CAC flag is not present in the SFF file. In this case, a CAC flag value may be set to ‘1’ for the following reasons. If content in the SFF file is ‘self-encoded content’, a CAC flag for the self-encoded content, which is created in a self-encoding and encryption process, should be included in the SFF file. However, since the CAC flag is not present in the current SFF file, the content may be estimated as ‘prepared content’, not ‘self-encoded content’. As described above, if a value of the CAC flag information is set to ‘1’, then the SFF file includes ‘prepared content’. Therefore, a value of the CAC flag is set to 1 in order to indicate that the content is ‘prepared content’. Thereafter, the DRM device may return to operation 411.

If a CAC flag is present in operation 412, the DRM device may determine or identify a value of the CAC flag in operation 413. If a value of the CAC flag is ‘0’, the DRM device may proceed to operation 421, and if a value of the CAC flag is ‘1’, the DRM device may proceed to operation 431.

As described above, if a value of the CAC flag is ‘0’, the SFF file includes ‘self-encoded content’, for playback of which the additional CAC information is not required. Therefore, the DRM device does not need to receive the CAC information from the DRM server. On the other hand, if a value of the CAC flag is ‘1’, the SFF file includes ‘prepared content’, for which the CAC information is required to be received from the DRM server in order to reproduce the content. Due to this difference, operations following operation 421 may be different from operations following operation 431.

Operations following operation 421 are as follows. In this case, since a value of the CAC flag is set to ‘0’, the SFF file includes ‘self-encoded content’, for playback of which the additional CAC information is not required to be received.

In operation 421, the DRM device may read a value of offsetToCAC, and determine in operation 422 whether a CAC box is present. If it is determined in operation 422 that a CAC box is present, the DRM device may cease operation in operation 423. The reason for ceasing operation in operation 423 is because the DRM device may presume that there is an error in the SFF file. In other words, since the content included in the current SFF file is ‘self-encoded content’, for which a CAC flag value is set to ‘0’, the CAC box should not be present. However, if a CAC box is detected, then there is an error in the current SFF file (e.g., there is an error in a value of the CAC flag that is set to ‘0’). Therefore, in operation 423, the DRM device may cease operation without playing the SFF file, having determined that there is an error in the current SFF file.

On the other hand, if it is determined in operation 422 that the CAC box is not present, the DRM device may attempt playback of the content in operation 424. Since the CAC box is not required for playback of the self-encoded content, if the CAC box is not present in the SFF file, it means that there is no error in the SFF file. Therefore, the DRM device may play content included in the SFF file (without receiving additional CAC information from the DRM server).

Operations following operation 431 are as follows. In this case, since a value of the CAC flag is set to ‘1’, the SFF file includes ‘prepared content’, for which the additional CAC information is required to be received from the DRM server in order to reproduce the content.

In operation 431, the DRM device may read a value of offsetToCAC, and determine in operation 432 whether a CAC box is present.

If it is determined in operation 432 that a CAC box is present, the DRM device may play the content using the CAC information in operation 433. Specifically, the DRM device may decrypt an encryption key using the CAC information included in the SFF file, and play the content using the decrypted encryption key.

On the other hand, if it is determined in operation 432 that the CAC is not present, the DRM device may request CAC information from the DRM server in operation 434, and receive the CAC information in operation 435. Thereafter, in operation 433, the DRM device may play the content using the received CAC information.

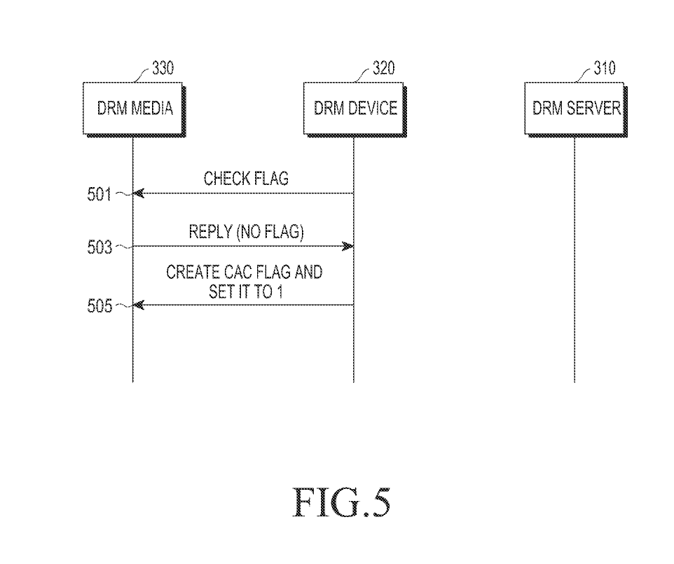

FIG. 5 illustrates an operation of a DRM device for prepared content, for which a CAC flag is not present, according to an embodiment of the present disclosure. For reference, if the CAC flag is not present, then the content has not been licensed with respect to specific media before. A description of FIG. 5 corresponds to operation 410 in FIG. 4.

Referring to FIG. 5, in operation 501, the DRM device 320 may deliver a signal for determining whether a CAC flag is present in an SFF file in the DRM media 330, to the DRM media 330. If a reply indicating that the CAC flag is not present in the SFF file is received from the DRM media 330 in operation 503, the DRM device 320 may generate a CAC flag having a value of ‘1’ and insert the CAC flag into the SFF file in operation 505. The reason for setting the CAC flag to ‘1’ is because the content is estimated as ‘prepared content’ as described in operation 414 in FIG. 4.

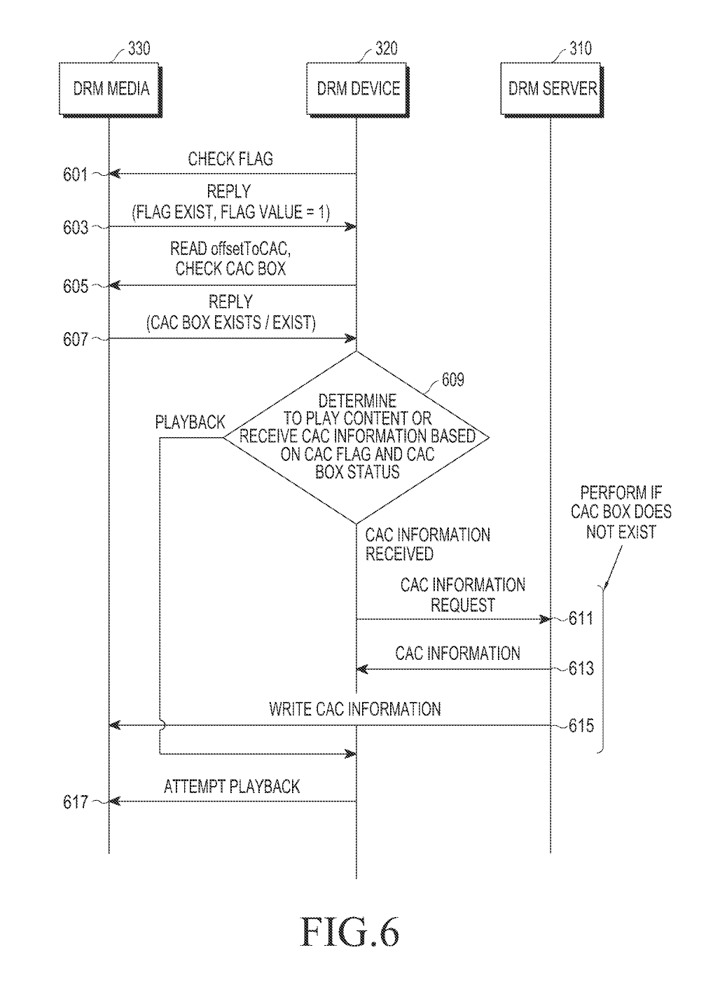

FIG. 6 illustrates an operation of a DRM device for prepared content, for which a CAC flag is present, according to an embodiment of the present disclosure. For reference, if the CAC flag is present, then the content has been licensed with respect to specific media before. Since it is assumed in FIG. 6 that the content is ‘prepared content, a value of the CAC flag may be set to ‘1’, if there is no error in the SFF file.

Referring to FIG. 6, in operation 601, the DRM device 320 may deliver, to the DRM media 330, a signal for determining whether a CAC flag is present in an SFF file in the DRM media 330. In operation 603, the DRM device 320 may receive, from the DRM media 330, a reply indicating that a CAC flag is present in the SFF file and a value of the CAC flag is ‘1’.

In operation 605, the DRM device 320 may read offsetToCAC to find a position of a CAC box, and inquire of the DRM media 330 whether a CAC box is present. In operation 607, the DRM media 330 may send a reply indicating the presence/absence of a CAC box. In operation 609, based on the value of the CAC flag and the presence/absence of the CAC box, the DRM device 320 may determine to receive CAC information from the DRM server 310, or determine to play the content in the SFF file without receiving the CAC information.

If the CAC box is present, the DRM device 320 may play the content using the CAC information in the CAC box in operation 617. If the CAC box is not present, the DRM device 320 may request CAC information from the DRM server 310 in operation 611, receive the CAC information in operation 613, and write the received CAC information in the SFF file in the DRM media 330 in operation 615. Thereafter, in operation 617, the DRM device 320 may play the content using the written CAC information.

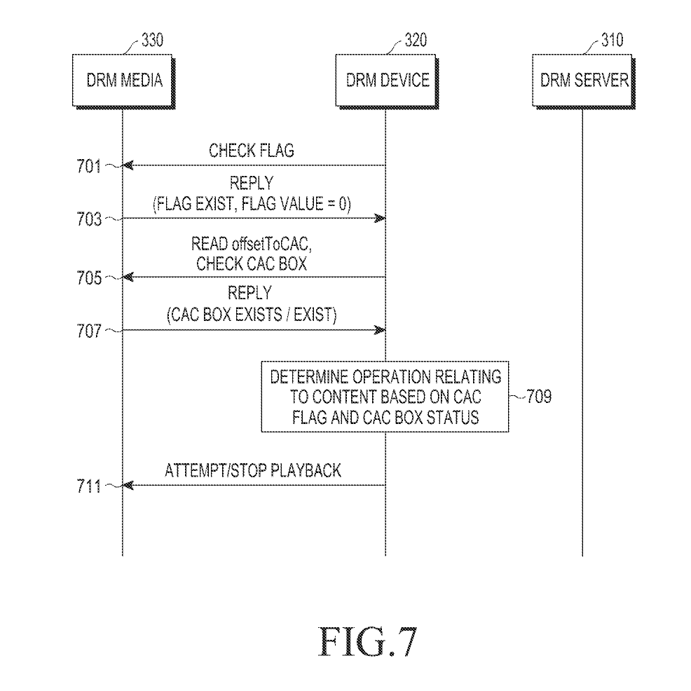

FIG. 7 illustrates an operation of a DRM device for self-encoded content, for which a CAC flag is present, according to an embodiment of the present disclosure.

Referring to FIG. 7, in the case of ‘self-encoded content, when the self-encoded content is encoded by a home device that creates the content, a CAC flag is generated together. Therefore, it is assumed in FIG. 7 that the self-encoded content includes CAC flag information. In addition, since the self-encoded content is premised in FIG. 7, a value of the CAC flag is assumed to be set to ‘0’.

In operation 701, the DRM device 320 may send, to the DRM media 330, a signal for determining whether a CAC flag is present in an SFF file in the DRM media 330. In operation 703, the DRM device 320 may receive, from the DRM media 330, a reply indicating that a CAC flag is present in the SFF file and a value of the CAC flag is 0.

In operation 705, the DRM device 320 may read a value of offsetToCAC, and inquire of the DRM media 330 whether a CAC box is present. In operation 707, the DRM media 330 may send a reply indicating the presence/absence of a CAC box. In operation 709, the DRM device 320 may operate based on the value of the CAC flag and the presence/absence of the CAC box\.

If the CAC box is present, the DRM device 320 may cease operation without playing the SFF file, determining that there is an error in the current SFF file. If the CAC box is not present, then there is no error in the SFF file, since the CAC box is not required for playback of self-encoded content. Therefore, the DRM device 320 may play the content included in the SFF file.

Aspects of an embodiment of the present disclosure may be implemented as a computer-readable code in a computer-readable recording medium. The computer-readable recording medium may be any data storage device capable of storing the data that can be read by the computer system. Examples of the computer-readable recording medium may include a Read-Only Memory (ROM), a Random-Access Memory (RAM), Compact Disc ROMs (CD-ROMs), magnetic tapes, floppy disks, optical data storage devices, and/or carrier waves (such as data transmission over the Internet). The computer-readable recording medium may be distributed over the computer systems that are connected to the network. Therefore, the computer-readable code may be stored and executed in a distributed manner. In addition, the functional programs, code, and code segments for achieving the present disclosure may be easily interpreted by the programmers skilled in the art to which the present disclosure is applied.

It will be appreciated that the method and apparatus according to an embodiment of the present disclosure may be implemented in the form of hardware, software, or a combination thereof. The software may be stored in a volatile or non-volatile storage device (e.g., an erasable/re-writable ROM), a memory (e.g., a RAM, a memory chip, a memory device or a memory Integrated Circuit (IC)), or an optically/magnetically recordable machine (e.g., computer)-readable storage medium (e.g., a CD, a Digital Versatile Disc (DVD), a magnetic disk, or a magnetic tape). The method according to an embodiment of the present disclosure may be implemented by a computer or a mobile phone that includes a controller and a memory. The memory may be one example of the machine-readable storage medium suitable to store a program or programs including instructions for implementing various embodiments of the present disclosure.

Therefore, the present disclosure may include a program including the code for implementing the method and apparatus as defined by the appended claims, and a machine (or computer)-readable storage medium for storing the program. The program may be electronically carried on any media such as communication signals that are transmitted through wired/wireless connections.

The content playback apparatus according to an embodiment of the present disclosure may receive and store the program from a program server, to which the content playback apparatus is connected by wires or wirelessly. The program server may include a memory for storing a program including instructions for allowing the content playback apparatus to perform the content playback method, and storing information necessary for the content playback method, a communication unit for performing wired/wireless communication with the content playback apparatus, and a controller for transmitting the program to the content playback apparatus at the request of the content playback apparatus or automatically.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for playing content included in a media file in a playback apparatus, the method comprising:
obtaining file status indication information indicating a status of the media file from the media file;
determining whether a content authentication code (CAC) for playback of the content is included in the media file, if the file status indication information indicates that the content included in the media file is self-encoded content; and
playing the content, if the CAC is not included in the media file;
wherein the self-encoded content is content that can be played without the CAC.

2. The method of claim 1, further comprising, if the CAC is included in the media file, avoiding playing the content, determining that there is an error in the media file.

3. The method of claim 1, further comprising:
determining whether the CAC for playback of the content is included in the media file, if the file status indication information indicates that the content included in the media file is prepared content;
requesting and receiving the CAC from a Digital Rights Management (DRM) server, if the CAC is not included in the media file; and
playing the content based on the received CAC;
wherein the prepared content is content that can be played without the CAC.

4. The method of claim 3, further comprising playing the content using the CAC included in the media file, if the CAC is included in the media file.

5. The method of claim 1, further comprising:
before the obtaining of the file status indication information, determining whether the file status indication information is included in the media file;
if the file status indication information is not included in the media file, estimating the content included in the media file as prepared content, and setting the file status indication information to a predetermined value so as to indicate that the content included in the media file is the prepared content; and
inserting the file status indication information that is set to the predetermined value, into the media file;
wherein the prepared content is content, for which the CAC is required in order to reproduce the prepared content.

6. The method of claim 1, wherein the file status indication information is flag information with a size of 1 bit.

7. The method of claim 1, wherein the file status indication information is included in the media file, if the media file has been licensed with respect to a specific medium through DRM at least once before.

8. The method of claim 1, wherein the media file is encoded in one of a Common File Format (CFF) and a Standard File Format (SFF).

9. A playback apparatus for playing content included in a media file, the playback apparatus comprising:
a media file analyzer configured to obtain file status indication information indicating a status of the media file from the media file; and
a controller configured to:
determine whether a content authentication code (CAC) for playback of the content is included in the media file, if the file status indication information indicates that the content included in the media file is self-encoded content, and
play the content, if the CAC is not included in the media file;
wherein the self-encoded content is content that can be played without the CAC.

10. The playback apparatus of claim 9, wherein the controller is configured to avoid playing the content if the CAC is included in the media file, determining that there is an error in the media file.

11. The playback apparatus of claim 9,
wherein the controller is configured to determine whether the CAC for playback of the content is included in the media file, if the file status indication information indicates that the content included in the media file is prepared content, and to determine to request the CAC from a Digital Rights Management (DRM) server, if the CAC is not included in the media file;
wherein the playback apparatus further comprises a transceiver configured to request and receive the CAC from the DRM server depending on the determination of the controller;
wherein the controller is configured to play the content based on the received CAC; and
wherein the prepared content is content that can be played without the CAC.

12. The playback apparatus of claim 11, wherein the controller is configured to play the content based on the CAC included in the media file, if the CAC is included in the media file.

13. The playback apparatus of claim 9,
wherein the controller is configured to, before obtaining the file status indication information, determine whether the file status indication information is included in the media file, and to estimate the content included in the media file as prepared content if the file status indication information is not included in the media file;
wherein the playback apparatus further comprises a media file generator configured to set the file status indication information to a predetermined value so as to indicate that the content included in the media file is the prepared content, and to insert the file status indication information that is set to the predetermined value, into the media file; and
wherein the prepared content is content, for which the CAC is required in order to reproduce the prepared content.

14. The playback apparatus of claim 9, wherein the file status indication information is flag information with a size of 1 bit.

15. The playback apparatus of claim 9, wherein the file status indication information is included in the media file, if the media file has been licensed with respect to a specific medium through DRM at least once before.

16. The playback apparatus of claim 9, wherein the media file is encoded in one of a Common File Format (CFF) and a Standard File Format (SFF).
